(19) United States
(12) Patent Application Publication
(10) Pub. No.: US 2014/0097260 A1
(43) Pub. Date: Apr. 10, 2014

(54) Thermal Protection System For Pressurized Gas Cylinders In Vehicles

(71) Applicant: Michael Jon Veenstra, (US)

(72) Inventor: Michael Jon Veenstra, Southgate, MI (US)

(73) Assignee: FORD GLOBAL TECHNOLOGIES, LLC, Dearborn, MI (US)

(21) Appl. No.: 13/644,927

(22) Filed: Oct. 4, 2012

(51) Int. Cl. F16K 17/00; B23P 11/00

(52) U.S. Cl. 236/92 C; 29/428

(57) ABSTRACT

Disclosed is a thermal protection system for a pressurized gas cylinder. The system includes a pressurized gas cylinder 2, a temperature-activated pressure relief device 4 coupled with the pressurized gas cylinder 2, a thermal concentrator 6 integrated with an opening 10 in a vehicle panel 8, the panel being located in proximity to the cylinder; and an opening in the concentrator 6 directed toward the pressure relief device 4. The concentrator may be a funnel shaped shield, flange or metal channel. Accelerant 24 and wicking materials 20, 22 may be used to aid flame progression.

### BACKGROUND OF THE INVENTION

1. Field of the Invention

The present invention relates to a thermal protection system for pressurized gas cylinders, more particularly, a fire protection system for pressurized gas cylinders used as fuel storage in vehicles.

2. Background of the Related Art

Gas cylinder designs for storing compressed gases including propane, methane and hydrogen have been developed that utilize light-weight composite materials. Composite materials are valued for their strength, but they are more susceptible to failure from exposure to high-temperatures and fire than metal tanks. The composite overwrap of a pressurized cylinder may experience structural degradation in the prolonged presence of high temperatures. High temperatures cause the resin to exceed its glass transition point and render the fiber matrix unsupported. High gas pressures within the tank exacerbate this failure mode and may lead to a gas breach within minutes of flame or high temperature exposure. Temperature-activated pressure relief devices (TPRDs) are known as a mechanism for releasing gas in the presence of a high-temperature or fire. If a TPRD reaches a certain temperature threshold, the device activates and reduces the cylinder pressure to avoid a cylinder rupture.

In the case of a localized fire in the vehicle, the heat or flame may not be near the TPRD, but at the opposing end of the cylinder or other concentrated location. The cylinder structural integrity may be compromised before the TPRD is engaged, resulting in a rupture of the cylinder. Localized fire can occur due to a fire originating from another area in the vehicle which then progresses towards the pressurized gas cylinder in a non-engulfing flame path due to the vehicle architecture.

Prior art shows the use of heat conducting mesh layers that are placed around the entire cylinder (JP20066137233A2), the use of a thermally activated fuse cord wrapped around the cylinder (U.S. Pat. No. 6,382,232), and the use of a low melting matrix alloy dispersal in connection with a TPRD (U.S. Pat. No. 6,006,774). These systems use additional materials and devices that increase the complexity and cost without addressing the undesired heating of the cylinder. The present thermal protection system is an integrated solution that provides advantages over the prior art through simplification and robustness of the localized fire mitigation for a pressurized gas cylinder on a vehicle.

The present invention improves on earlier designs by providing a low-cost pressurized cylinder thermal protection system, comprising: a pressurized gas cylinder, a temperature-activated pressure relief device coupled with the pressurized gas cylinder, a thermal concentrator integrated with an opening in a vehicle panel, the panel being located in proximity to the cylinder; and one end of the concentrator directed toward the temperature-activated pressure relief device.

### SUMMARY OF THE INVENTION

Accordingly, the present invention is directed to a thermal protection system for pressurized gas cylinders in use in vehicles that substantially obviates one or more problems due to limitation and disadvantages of the related art.

An object of the present invention is to provide a thermal protection system to avoid compromise of the structural integrity of the cylinder in the event of a localized fire in the vehicle by concentrating the fire toward the TPRD, thereby engaging the TPRD, and protecting the remainder of the cylinder.

To achieve the object and other advantages, according to one aspect of the present invention, there is provided a pressurized cylinder thermal protection system, comprising: a pressurized gas cylinder, a temperature-activated pressure relief device coupled with the pressurized gas cylinder, a thermal concentrator integrated with an opening in a vehicle panel, the panel being located in proximity to the cylinder; and one end of the concentrator directed toward the temperature-activated pressure relief device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention are incorporated in and constitute a part of the application, illustrate embodiment(s) of the invention and together with the description serve to explain the principle of the invention. In the drawings:

FIG. 1 is a side view illustration of the thermal protection system according to the present invention;

FIG. 2 is an enlarged top view of the thermal protection system illustrated in FIG. 1;

FIG. 3 is a side view of a second embodiment of the thermal protection system;

FIG. 4 is a side view of a third embodiment of the thermal protection system; and

FIG. 5 is a side view of a fourth embodiment of the thermal protection system.

### DETAILED DESCRIPTION OF THE PREFERRED EMBODIMENTS

A preferred embodiment according to the present invention will now be explained with reference to the accompanying drawings.

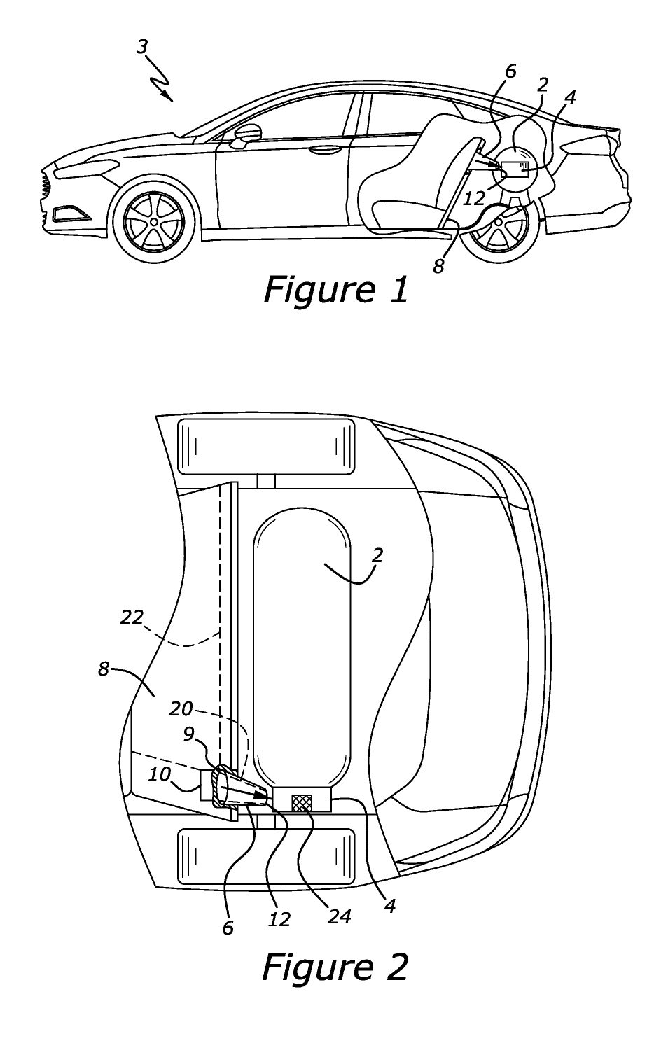

FIG. 1 is a side view illustration of the thermal protection system according to the present invention. A compressed gas cylinder 2 is mounted in a vehicle 3. A temperature activated pressure relief device (TPRD) 4 is coupled to gas cylinder 2. The use of a TPRD with a compressed gas cylinder is well known in the prior art. As known in the art, the TPRD can be integrated with or connected to the cylinder valve. Gas cylinder 2 is located near a vehicle body panel 8. In the embodiment illustrated by FIG. 1, gas cylinder 2 is located near the rear of vehicle 3, behind the back passenger seat of vehicle 3. In a non-illustrated alternative embodiment, cylinder 2 may be located under the vehicle, and vehicle floor pan.

FIG. 2 is an enlarged view of the system. A thermal concentrator 6 is integrated with body panel 8 such that one open end 9 of thermal concentrator 6 is joined with an opening 10 in body panel 8 and the opposing open end 12 of thermal concentrator 6 is directed toward TPRD 4.

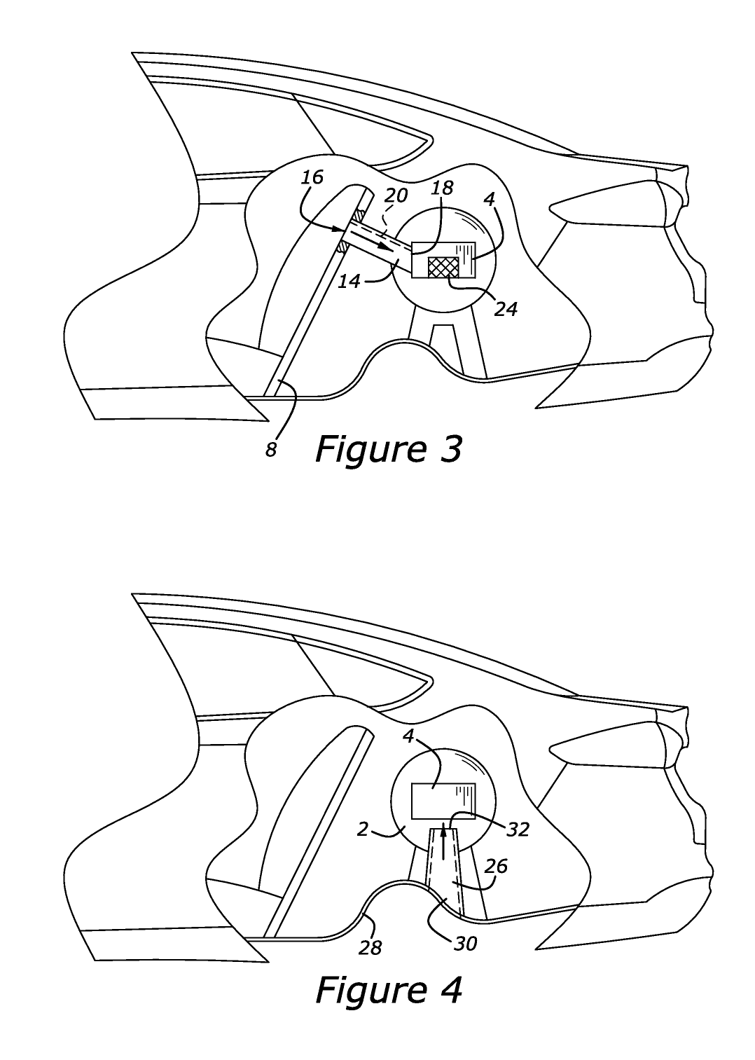

Thermal concentrator 6 may or may not be in physical contact with TPRD 4. A number of embodiments for the thermal concentrator 6 are proposed. Thermal concentrator 6 may be a metal funnel shaped shield, as illustrated in FIG. 1. In this embodiment, thermal concentrator 6 is in proximate contact with TPRD 4 but not physically connected to TPRD 4. Thermal concentrator 6 may alternatively be a flange (not illustrated). FIG. 3 illustrates another embodiment of the invention in which a metal channel 14 serves as the thermal concentrator. In this embodiment, metal channel 14 may be joined to panel opening 10 at one end 16 of metal channel 14 and joined to TPRD 4 at the opposing end 18 of metal channel 14. Thermal concentrators may be integrated to body panels through welds, bolts, or other connectors known in the art.

As illustrated in FIGS. 2 and 3, a wicking material 20 may be in communication with thermal concentrator 6. Wicking material 20 may be placed on thermal concentrator 6 such that it will enhance the ability of thermal concentrator 6 to direct flame or heat or both toward TPRD 4. Additional wicking material 22 may be placed in communication with vehicle body panel 8. Wicking material 22 can be placed to direct a localized flame toward thermal concentrator 6, which in turn directs flame and heat toward the TPRD 4 and away from the rest of gas cylinder 2. Optionally, wicking material 20 may be adhered to thermal concentrator 6 and body panel 8 in the form of paint or a tape. Wicking material 20 is selected from known materials that rapidly progress flame on heat along a path.

If a localized fire develops in vehicle 3 in an area away from gas cylinder 2 fuel system location, the concern arises that the structural integrity of gas cylinder 2 may be compromised or degraded to the point of rupture. To ameliorate or reduce that risk, the fire and its accompanying heat are directed and concentrated toward the TRPD 4 location so TRPD 4 is activated earlier and the pressure in gas cylinder 2 released in a controlled fashion away from the occupants and away from likely sources of combustibles. By directing the progression of the fire toward TRPD 4, the remainder of cylinder 2 is protected and the risk of rupture is greatly reduced.

Thermal concentrator 6 is integrated into body panel 8 proximate to gas cylinder 2. Fire is directed by concentrator 6 toward the fuel system location through opening 10 in body panel 8. The fire continues through thermal concentrator end 9 which is joined to opening 10, and then through thermal concentrator 6, then out through opposing end 12, which is directed toward TRPD 4. The path creation for the fire can be further directed by use of wicking material 20. Flames in proximity to wicking material 20 will cause it to ignite and be directed through thermal concentrator 6.

The system illustrated in FIGS. 2 and 3 may optionally include an accelerant 24 placed in close proximity to TPRD 4. When flame reaches accelerant 24, it will further increase the temperature at TPRD 4, and speed the release of pressure in gas cylinder 2.

FIG. 4 illustrates an alternative embodiment of the invention. In this alterative embodiment, a thermal concentrator 26 may be integrated with a floor pan 28. In this embodiment, one end 30 of thermal concentrator 26 is joined with an opening in floor pan 28 and the opposing end 32 of thermal concentrator 6 is directed toward TPRD 4.

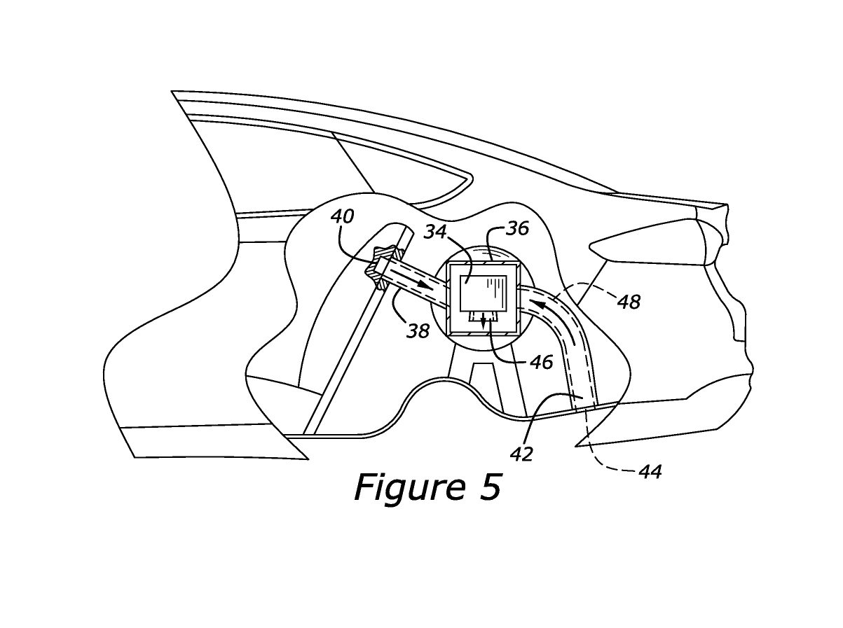

FIG. 5 illustrates another embodiment of the invention. In this embodiment, TPRD 34 is surrounded by an enclosure 36. Tubing 38 connects enclosure 36, to seat body panel opening 40. Other tubing 42, connects enclosure 36 to floor pan opening 44. Tubing 38, 42 are made of heat conducting materials. A vent 46 is provided for air flow and flame propagation. A localized fire can be directed through tubing 38, 42. Heat, flame, or a combination of heat and flame from tubing 38, 42 will create an oven effect around enclosure 36 and activate TPRD prior to tank failure. Tubing 38, 42 may include wicking material 48 in or on tubing 38, 42 to direct flame toward TPRD 34.

Additionally, a pressurized cylinder thermal protection method is disclosed wherein thermal concentrator 6 is integrated with opening 10 in vehicle panel 8. Panel 8 is located in proximity to gas cylinder 2, TPRD 4 is coupled to gas cylinder 2, and one open end 12 of concentrator 6 is directed toward TPRD 4.

The forgoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A pressurized cylinder thermal protection system, comprising:
a pressurized gas cylinder;
a temperature-activated pressure relief device coupled with the pressurized gas cylinder;
a thermal concentrator integrated with an opening in a vehicle panel, the panel being located in proximity to the cylinder; and
an opening in the concentrator directed toward the pressure relief device.

2. The thermal protection system of claim 1, wherein the concentrator is a funnel shaped shield.

3. The thermal protection system of claim 1, wherein the concentrator is a flange.

4. The thermal protection system of claim 1, wherein the concentrator is a metal channel.

5. The thermal protection system of claim 1, further comprising a wicking material in communication with the concentrator.

6. The thermal protection system of claim 5, further comprising a wicking material in communication with the vehicle panel.

7. The thermal protection system of claim 6, further comprising an accelerant in proximity to the thermal concentrator.

8. The thermal protection system of claim 1, wherein the vehicle panel is a seat back body panel.

9. The thermal protection system of claim 1, wherein the vehicle panel is a floor pan.

10. A pressurized cylinder thermal protection system, comprising:
a pressurized gas cylinder;
a temperature-activated pressure relief device coupled with the pressurized gas cylinder;
an enclosure surrounding the pressure relief device;
a thermal concentrator integrated with an opening a vehicle panel, the panel being located in proximity to the cylinder;
an opening in the concentrator directed toward the pressure relief device; and
tubing in connection with the enclosure and the vehicle panel.

11. The thermal protection system of claim 10 further comprising tubing in connection with the enclosure and a second vehicle panel.

12. The thermal protection system of claim 11, wherein the second vehicle panel is a floor pan.

13. A method of pressurized cylinder thermal protection, comprising:
integrating a thermal concentrator with an opening in a vehicle panel, the panel being located in proximity to a pressurized gas cylinder;
coupling a temperature-activated pressure relief device with the pressurized gas cylinder; and
including an opening in the concentrator directed toward the pressure relief device.

14. The method of thermal protection in claim 13, further comprising:
placing a wicking material in communication with the concentrator.

15. The method of thermal protection in claim 13, wherein the concentrator is a funnel shaped shield.

16. The method of thermal protection in claim 13, wherein the vehicle panel is a seat back body panel.

17. The method of thermal protection in claim 13, wherein the vehicle panel is a floor pan.

18. The method of thermal protection in claim 13, wherein the concentrator is a metal channel.

19. The method of thermal protection in claim 14, further comprising placing a wicking material in communication with the vehicle panel.

20. The method of thermal protection in claim 19, further comprising placing an accelerant in proximity to the pressure relief device.
